(19) United States
(12) Patent Application Publication
(10) Pub. No.: US 2010/0182124 A1
(43) Pub. Date: Jul. 22, 2010

(54) ELECTRONIC DEVICE AND FINGERPRINT IDENTIFYING METHOD EMPLOYING THE SAME

(75) Inventor: MENG-CHIEH CHOU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/610,481

(22) Filed: Nov. 2, 2009

(30) Foreign Application Priority Data
Jan. 16, 2009 (CN) 200910300233.2

(51) Int. Cl. G06F 7/04

(52) U.S. Cl. 340/5.53

(57) ABSTRACT

An exemplary electronic device includes a fingerprint sensing unit, a signal converting unit, a processor, and a storage unit. The fingerprint sensing unit, the signal converting unit, the processor, and the storage unit are electrically connected in series. The fingerprint sensing unit includes a touch sensing module for obtaining a voltage signal via elastic deformation. The signal converting unit converts the voltage signal into digital fingerprint data. The processor computes and processes the digital fingerprint data to generate corresponding fingerprint characteristic information of a user, and controls the storage unit to compare the fingerprint characteristic information of the user with the fingerprint characteristic information prestored in the storage unit to determine whether to start up the electronic device into a normal working state or not.

### BACKGROUND

1. Technical Field

The disclosure generally relates to electronic devices, more particularly, to an electronic device having fingerprint identification function, and a fingerprint identifying method employing the same.

2. Description of the Related Art

Electronic devices, such as mobile telephones and personal digital assistants (PDAs), usually have important personal information stored therein. Thus, it is necessary to set an identity authentication and password to protect the stored personal information from being inadvertently leaked or stolen.

Fingerprint identification is widely used as an identity authentication method, which has high security standard, and is easy to use. At present, some electronic devices are installed with external fingerprint identification devices to carry out the fingerprint identification function. However, the fingerprint identification devices are generally costly, large in size, and insufficient accuracy, which may not meet needs of the users.

Therefore, there is room for improvement within the art.

### BRIEF DESCRIPTION OF THE DRAWINGS

Many aspects of an electronic device and a fingerprint identifying method employing the same can be better understood with reference to the following drawings. The components in the drawings are not necessarily drawn to scale, the emphasis instead being placed upon clearly illustrating the principles of the exemplary electronic device and fingerprint identifying method employing the same. Moreover, in the drawings, like reference numerals designate corresponding parts throughout the several views. Wherever possible, the same reference numbers are used throughout the drawings to refer to the same or like elements of an embodiment.

FIG. 1 is a block diagram of an electronic device, according to an exemplary embodiment.

FIG. 2 is a cross-sectional view of a touch sensing module of the electronic device shown in FIG. 1.

FIG. 3 is a flow chart illustrating a fingerprint identifying method, according to an exemplary embodiment.

### DETAILED DESCRIPTION OF THE EMBODIMENTS

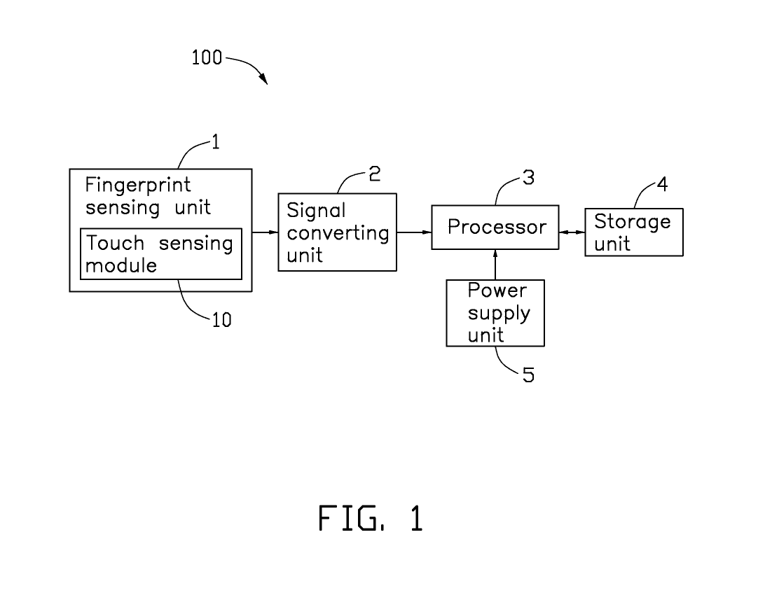

FIG. 1 shows an exemplary embodiment of an electronic device 100 with fingerprint identification function, such as a mobile phone, PDA. The mobile phone is taken here as an exemplary application. The electronic device 100 includes a fingerprint sensing unit 1, a signal converting unit 2, a processor 3, a storage unit 4, and a power supply unit 5. The fingerprint sensing unit 1, the signal converting unit 2, the processor 3, and the storage unit 4 are electrically connected in series, and the processor 3 is further electrically connected to the power supply unit 5.

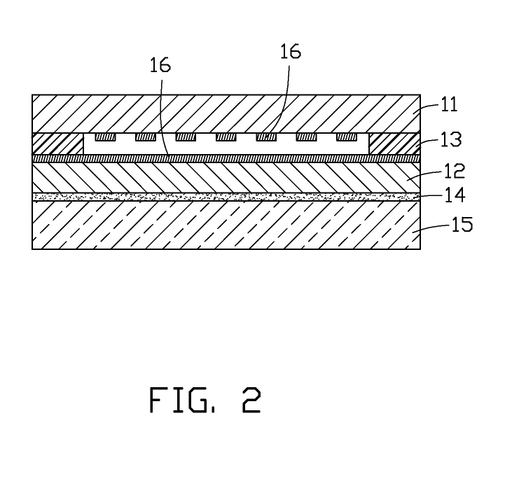

The fingerprint sensing unit 1 includes a touch sensing module 10 for obtaining fingerprint information of a user. Further referring to FIG. 2, the touch sensing module 10 can be combined with an existing touch liquid crystal display (LCD) screen. Thus, the fingerprint sensing unit 1 can be combined with the existing display screen to form a touch display screen.

The touch sensing module 10 includes a first conductive film 11, a second conductive film 12, a plurality of spacers 13, an adhesive layer 14, and a backing panel 15 in turn. Each relative surface of the first conductive film 11 and the second conductive film 12 defines a plurality of conductive electrodes 16. The other surface of the second conductive film 12 is affixed to the backing panel 15 via the adhesive layer 14. The first conductive film 11 and the second conductive film 12 are electrically connected to the signal converting unit 2.

The first conductive film 11 can be made from low-impedance and transparent conductive material, such as indium tin oxide (ITO), and is mounted at the outermost layer of the touch sensing module 10. The first conductive film 11 can be a touch surface for inputting commands to the electronic device 100. The second conductive film 12 can be made from the low-impedance and transparent conductive material as described above. When pressing the first conductive film 11, the first conductive film 11 contacts with the second conductive film 12 to generate a voltage signal.

The spacers 13 can be made from plastic and other insulating material. The spacers 13 are mounted between the first conductive film 11 and the second conductive film 12 to prevent the conductive films 11 and 12 contacting with each other.

In practical use, thickness of the conductive films 11 and 12 and the size the spacers 13 are relatively small, facilitating weight reduction and small size of the fingerprint sensing unit 1.

The backing panel 15 for supporting the conductive films 11, 12 can be made from transparent and insulating material, such as transparent glass, acrylic, polyester etc.

Each conductive electrode 16 has a long-strip shape, the conductive electrodes 16 of the first conductive film 11 are parallel with each other, and the conductive electrodes 16 of the second conductive film 12 are parallel with each other. The conductive electrodes 16 of the first conductive film 11 are perpendicular with the conductive electrodes 16 of the second conductive film 12. The voltage of every two adjacent conductive electrodes 16 is equal to or less than 0.015 volt, so that the voltage resolution (e.g., the ability of identifying small voltage) of the touch sensing module 10 is equal to or more than 320×240, which can improve the fingerprint identification accuracy of the touch sensing module 10.

When a finger presses the first conductive film 11, the first conductive film 11 produces elastic deformation, resulting in the conductive electrodes 16 of the first conductive film 11 and the second conductive film 12 contacting with each other. Thus, the conductive films 11 and 12 generate different voltage signals corresponding to the pressed area, and the voltage signals are send to the signal converting unit 2. The different voltage signals represent corresponding fingerprint characteristic information.

Referring to FIG. 1, the signal converting unit 2 is configured for receiving the voltage signals from the fingerprint sensing unit 1, and converting the voltage signals into corresponding digital fingerprint data after modulating and sampling. The digital fingerprint data are sent to the processor 3 in the form of digital signals.

The processor 3 is configured for computing and processing the fingerprint data to generate corresponding fingerprint characteristic information. The storage unit 4 defines a fingerprint characteristic information database therein which prestores the fingerprint characteristic information of the user. The processor 3 compares the fingerprint characteristic information of the user with the fingerprint characteristic information prestored in the storage unit 4. If the fingerprint characteristic information of the user is same with the fingerprint characteristic information prestored in the storage unit 4, access is granted to use the electronic device 100 in a normal operating state, otherwise the electronic device 100 is into locked state. The storage unit 4 can be combined with an existing storage device, such as flash, electrically erasable programmable read only memory (EEPROM), etc.

The power supply unit 5 can be a chargeable battery, such as a lithium battery, which is configured for powering the electronic device 100.

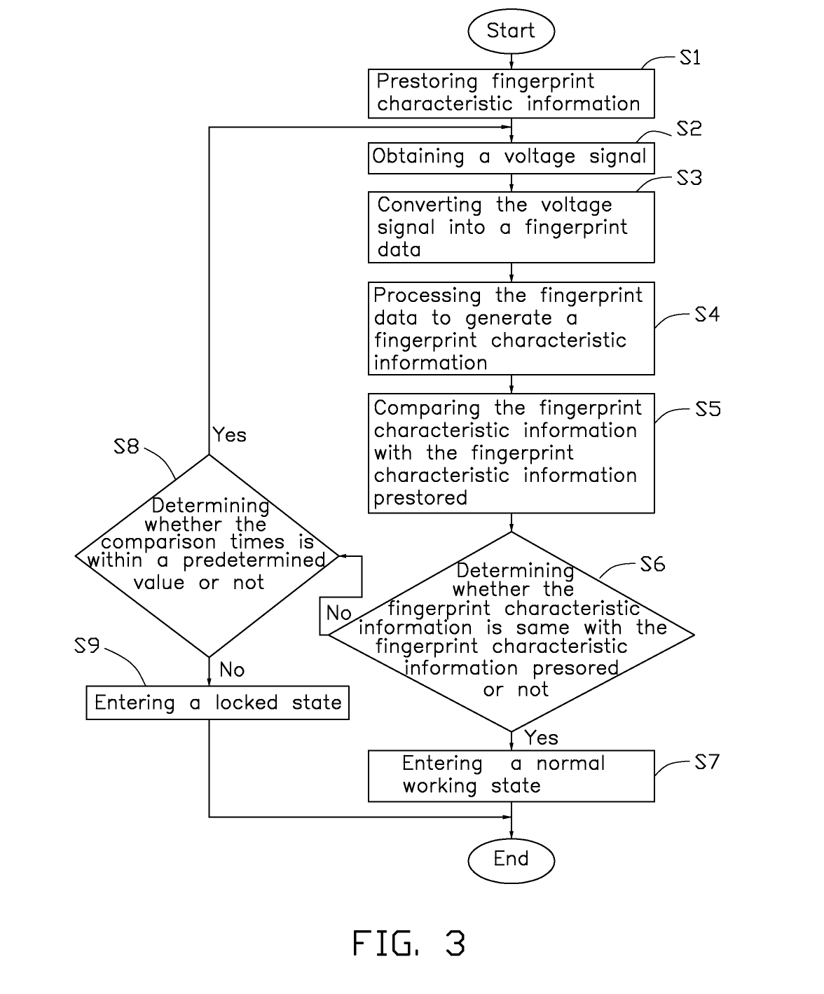

Also referring to FIG. 3, a fingerprint identifying method in accordance with an exemplary embodiment is depicted. The process of the fingerprint identifying method may at least include the following steps:

In step S1, an electronic device 100 with fingerprint identification function is provided, which prestores fingerprint characteristic information.

In step S2, the touch sensing module 10 obtains a fingerprint of an user and generates a voltage signal and sends the voltage signal to the signal converting unit 2.

In step S3, the signal converting unit 2 modulates and samples the voltage signal to generate a digital fingerprint data, and send the digital fingerprint data to the processor 3.

In step S4, the processor 3 computes and processes the digital fingerprint data to generate corresponding fingerprint characteristic information of the user.

In step S5, the processor 3 compares the fingerprint characteristic information of the user with the fingerprint characteristic information prestored in the storage unit 4.

In step S6, the processor 3 determines whether the fingerprint characteristic information of the user is same with the fingerprint characteristic information prestored in the storage unit 4 or not. If the fingerprint characteristic information of the user is same with the fingerprint characteristic information prestored in the storage unit 4, then the process goes to step S7, or the process goes to step S8.

In step S7, the processor 3 sends a starting signal to grant access to use the electronic device 100 in a normal operating state.

In step S8, the processor 3 determines whether the comparison times are within a predetermined value (e.g. 3 times) or not. If the comparison time is more than the predetermined value, then the process goes to step S9. If the comparison times are less than or equal to the predetermined value, then the process repeats the steps S2 to S6 to compare the fingerprint characteristic information of the user with the fingerprint characteristic information prestored in the storage unit 4.

In step S9, the processor 3 sends a locked signal to lock the electronic device 100 and make the electronic device enter a locked state.

In the electronic device 100 with fingerprint identification function of the exemplary embodiment, the touch sensing module 10 can obtain the fingerprint of an user to realize the fingerprint identification function. The touch sensing module 10 has a thin structure and can combined with the existing touch display screen, thus the fingerprint sensing unit 1 can replace other fingerprint identification device with larger size. Furthermore, the touch sensing module 10 has high voltage resolution, and a high fingerprint identification accuracy than the conventional fingerprint identification device.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. An electronic device with fingerprint identification function, comprising:
a fingerprint sensing unit including a touch sensing module for obtaining a voltage signal via elastic deformation;
a signal converting unit electrically connected to the fingerprint sensing unit, the signal converting unit configured for converting the voltage signal into digital fingerprint data;
a processor electrically connected to the signal converting unit, the processor configured for computing and processing the digital fingerprint data to generate corresponding fingerprint characteristic information of a user; and
a storage unit electrically connected to the processor, the storage unit configured for prestoring fingerprint characteristic information, wherein the processor compares the fingerprint characteristic information of the user with the fingerprint characteristic information prestored in the storage unit to determine whether to start up the electronic device into a normal working state or not.

2. The electronic device as claimed in claim 1, wherein the touch sensing module includes a plurality of conductive electrodes configured for improving resolution of the fingerprint characteristic information.

3. The electronic device as claimed in claim 2, wherein the touch sensing module further comprises a first conductive film and a second conductive film, which are electrically connected to the signal converting unit, the conductive electrodes are mounted on relative surfaces of the first conductive film and the second conductive film.

4. The electronic device as claimed in claim 3, wherein the conductive electrodes of the first conductive film are parallel with each other, the conductive electrodes of the second conductive film are parallel with each other, and the conductive electrodes of the first conductive film are perpendicular with the conductive electrodes of the second conductive film.

5. The electronic device as claimed in claim 3, wherein when the first conductive film produces the elastic deformation due to pressure, the conductive electrodes of the first conductive film and the second conductive film contact with each other to generate the voltage signal.

6. The electronic device as claimed in claim 3, wherein the touch sensing module further comprises a plurality of spacers mounted between the first conductive film and the second conductive film.

7. The electronic device as claimed in claim 3, wherein the touch sensing module further comprises an adhesive layer and a backing panel for supporting the first conductive film and the second conductive film, and the second conductive film is affixed to the backing panel via the adhesive layer.

8. The electronic device as claimed in claim 1, wherein the voltage of every two adjacent conductive electrodes is equal to or less than 0.015 volt.

9. The electronic device as claimed in claim 1, wherein the resolution of the touch sensing module is equal to or more than 320×240.

10. The electronic device as claimed in claim 1, wherein the fingerprint sensing unit can be combined with a display screen of the electronic device for obtaining the voltage via touching the display screen.

11. A fingerprint identifying method, comprising steps of:
providing an electronic device;
prestoring fingerprint characteristic information of a user in the electronic device;
obtaining a voltage signal;
converting the voltage signal into a digital fingerprint data;
processing the fingerprint data to generate a fingerprint characteristic information;
comparing the fingerprint characteristic information with the fingerprint characteristic information prestored in the electronic device; and
sending a starting signal to make the electronic device enter a normal working state or a locked state.

12. The fingerprint identifying method as claimed in claim 11, further comprising determining whether the fingerprint characteristic information is same with the fingerprint characteristic information prestored in the electronic device or not.

13. The fingerprint identifying method as claimed in claim 12, further comprising sending a starting signal to make the electronic device enter normal working state when the fingerprint characteristic information is same with the fingerprint characteristic information prestored in the electronic device.

14. The fingerprint identifying method as claimed in claim 12, further comprising determining whether the comparison times are within a predetermined value or not when the fingerprint characteristic information is different from the fingerprint characteristic information prestored in the electronic device.

15. The fingerprint identifying method as claimed in claim 14, going to the step of obtaining a voltage signal when the comparison times are less than or equal to the predetermined value.

16. The fingerprint identifying method as claimed in claim 14, further comprising sending a locked signal to make the electronic device enter a locked state when the comparison times are more than the predetermined value.
